(19) United States
(12) Patent Application Publication
(10) Pub. No.: US 2008/0134566 A1
(43) Pub. Date: Jun. 12, 2008

(54) Fishing Hook Holder

(76) Inventors: Benjamin Greaves, Staffordshire (GB); Matthew Allen, Birmingham (GB)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/567,232

(22) PCT Filed: Nov. 8, 2004
(86) PCT No.: PCT/GB04/04684

§ 371 Date: Nov. 9, 2006

(51) Int. Cl. A01K 97/06

(52) U.S. Cl. 43/57.1; 43/57.2

(57) ABSTRACT

The present invention relates to a fishing hook holder (10). The fishing hook holder (10) comprises a holder part (12) for receiving a hook. The holder past (12) is arranged so that a hook can at least partially straddle it. The fishing hook holder (10) can be stored in a receptacle (30). The fishing hook holder (10) can be either removable from the receptacle (30) or fixed thereto. The fishing hook holder (10) and the receptacle (30) can both float.

The present invention relates to a fishing hook holder.

Small fishing hooks are typically stored in a sealable bag or fishing tackle box and large fishing hooks are typically stored in a fishing tackle box.

One problem with the known fishing hook storage arrangements is that when a fisher person attempts to pick up a small hook it can be difficult and time consuming. It is known to use a magnet to pick up a desired hook but the magnet can pick up several hooks at once instead of just the single desired hook.

Another problem with the known fishing hook storage arrangements is that, when a fisher person picks up a pointed and/or barbed hook, the point and/or barb can easily cause injury to the fisher person. Moreover, it can be difficult to access the eye of the hook.

It can also be difficult to distinguish between differently sized hooks unless they are stored in separate compartments of a fishing tackle box.

According to a first aspect of the invention there is provided a fishing hook holder comprising a holder part for receiving a hook, the holder part being arranged so that a hook can at least partially straddle the holder part.

The holder part in accordance with the first aspect of the invention is preferably elongate. The holder part may be of uniform width. The holder part may vary in width along its length. In this way it can hold hooks of different sizes. Preferably the holder part tapers continuously from a first width at one end to a second, greater, width at the other end.

The holder part is preferably arranged to be a close fit with the inbound U-shaped surface of the hook. The holder part may have a generally circular cross section. In one preferred embodiment, the holder part has a generally circular cross section with a flat extending along at least part of its length. In another preferred embodiment, the holder part has a generally circular cross section and has two flats extending along at least part of its longitudinal length, the flats being spaced around the periphery from each other and, most preferably, approximately opposing each other.

The holder part may be of slightly greater diameter than the distance between the point of the hook and the opposing arm of the hook.

Part of the outer surface of the holder part may have a cross section which matches at least part of the inside surface of a hook.

The holder part may comprise a notch for receiving a hook barb.

The holder part may be made of at least two types of material. Most preferably, the first type of material is more resilient than the second type of material. For example, the holder part may comprise a relatively rigid core and a relatively resilient outer part.

The holder part preferably has indicia at a certain location along its length informing the user that a hook of certain size can be stored at that location. The holder part preferably has one or more hook receiving regions along its length. The hook receiving region preferably comprises an annular or partially annular recess to accommodate the looped part of a hook.

In some embodiments, the holder part may be arranged to receive small hooks. In such cases, the holder part may be of small width and difficult to handle because of its small width. The holder part may have one or more projections extending transversely therefrom, so as to increase the transverse dimension of the holder part. This can make the holder part easier to grip. Preferably, the or each projection extends radially, most preferably in the form of an annulus.

The holder part may be made from a resilient material. This allows easier mounting of oversized hooks on the holder part.

Preferably, the fishing hook holder comprises one or more hooks fitted thereto.

The or each hook is preferably placed around the fishing hook holder. The or each hook preferably does not penetrate the fishing hook holder material. Preferably, the entire length of the hook is visible during storage on the fishing hook holder. In this way, the size of the hook can be noted by a fisher person.

Preferably, where the book has an eye, the eye of the hook is free, i.e. accessible, when the hook is held on the fishing hook holder. Most preferably, the eye of the hook and the part of the hook adjacent the eye, are free when the hook is held on the fishing hook holder.

The fishing hook holder may have a marking or markings denoting the size of books suitable for the holder. The holder part preferably has indicia at a certain location along its length informing the user that a hook of certain size can be stored at that location, and at that location the holder part is preferably greater in dimension than the distance between the hook tip and opposing part of hook by a predetermined amount. In this way, the resilience of the hook material allows the hook to snap onto the holder part. Preferably, the holder part is greater in dimension than the distance between the hook tip and opposing part of hook.

The hook receiving region preferably comprises an annular or partially annular recess to accommodate the looped part of a hook. The longitudinal length of the annular recess may be slightly less than the width of a hook so that the walls of the recess act to retain the hook.

The fishing hook holder may be fluorescent so as to glow continuously and/or luminous so as to glow-in-the-dark.

The fishing hook holder may be made of a material of lower density than water.

The fishing hook holder may be stored on a key ring. The fishing hook holder may comprise a band or the like, enabling it to be worn over the and/or around the wrist.

The fishing hook holder may be stored in a receptacle. In one embodiment, the fishing hook holder may be removable from the receptacle, most preferably “snap fitting” into the receptacle. In another embodiment, the fishing hook holder may be completely fixed with respect to the receptacle. In yet another embodiment, part of the fishing hook holder may be fixed to the receptacle and part of the fishing hook holder may be movable with respect to the receptacle.

According to a second aspect of the invention there is provided a receptacle for a fishing hook holder in accordance with the first aspect of the invention, or any of the consistory clauses relating thereto, the receptacle comprising one or more fishing hook holder sites.

In one preferred embodiment, the receptacle comprises one or more resilient mouths for a corresponding number of fishing hook holders. In this way, fishing book holders can be “snap fitted” into the receptacle and removed from the receptacle. In another preferred embodiment, the receptacle comprises a fishing hook holder fixed thereto. In that embodiment, part of the fishing hook holder may be fixed to the receptacle and part of the fishing hook holder may be movable with respect to the receptacle. The fishing hook holder may be movable through an angle of say 90 degrees. Each of the fishing hook holders may be independently selectable and movable.

Preferably the fishing hook holder(s) laden with hook(s) is/are located in the receptacle such that eye(s) of hook(s) is/are uppermost.

The receptacle may comprise a removable housing for one or more fishing hook holders. Two longitudinal walls on the receptacle may receive each of four walls on the housing. The receptacle preferably comprises a plurality of housings, e.g. each housing being for different sized fishing hook holders.

The receptacle may be fluorescent so as to glow continuously and/or luminous so as to glow-in-the-dark.

The receptacle may have an integral magnifying glass to assist the fisher person. The receptacle is preferably watertight and is also preferably buoyant. The fishing hook holder receptacle may be made of a material of density lower than water, preferably of sufficiently low density that it floats even when the receptacle takes on water.

The fishing hook holder may be mounted on a thread or the like which can be worn around the neck of a fisher person. This arrangement allows a fisher person to keep their hands free so that they can handle the hook and bait. Such an arrangement is particularly useful when the fisher person is wading in a river and there is nowhere dry to put articles down.

According to a third aspect of the invention there is provided a method of making a fishing hook holder in accordance with the first aspect of the invention, the method comprising moulding the fishing hook holder.

According to a fourth aspect of the invention there is provided a fishing hook holder in accordance with the first aspect of the invention, third aspect of the invention or any of the consistory clauses relating thereto, having one or more hooks held thereon.

According to a fifth aspect of the invention there is provided a fishing hook holder assembly comprising a plurality of fishing hook holders in accordance with the first aspect of the invention, third aspect of the invention, fourth aspect of the invention or any of the consistory clauses relating thereto.

A fishing hook holder in accordance with the invention and a fishing hook holder receptacle in accordance with the invention will now be described briefly, and by way of example only, with reference to the following drawings, in which:—

FIG. 1 is a perspective view of a fishing hook holder in accordance with a first embodiment of the invention,

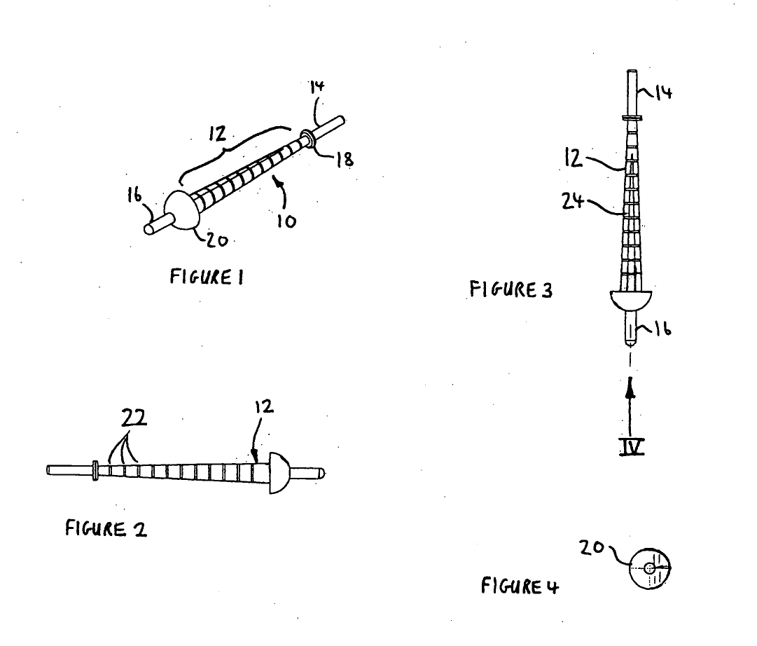

FIG. 2 is a side view of the fishing hook holder shown in FIG. 1,

FIG. 3 is a different side view of the fishing hook holder shown in FIG. 1,

FIG. 4 is an end view of the fishing hook holder shown in FIG. 1, taken in the direction of the arrow IV in FIG. 3,

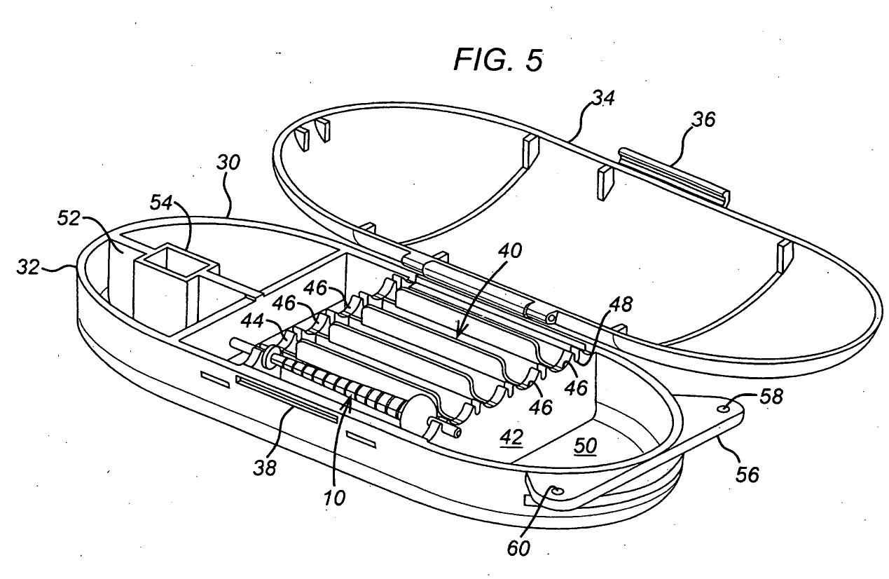

FIG. 5 is a perspective view of a fishing hook holder receptacle in accordance with the invention, showing the fishing hook holder of FIGS. 1 to 4 arranged therein,

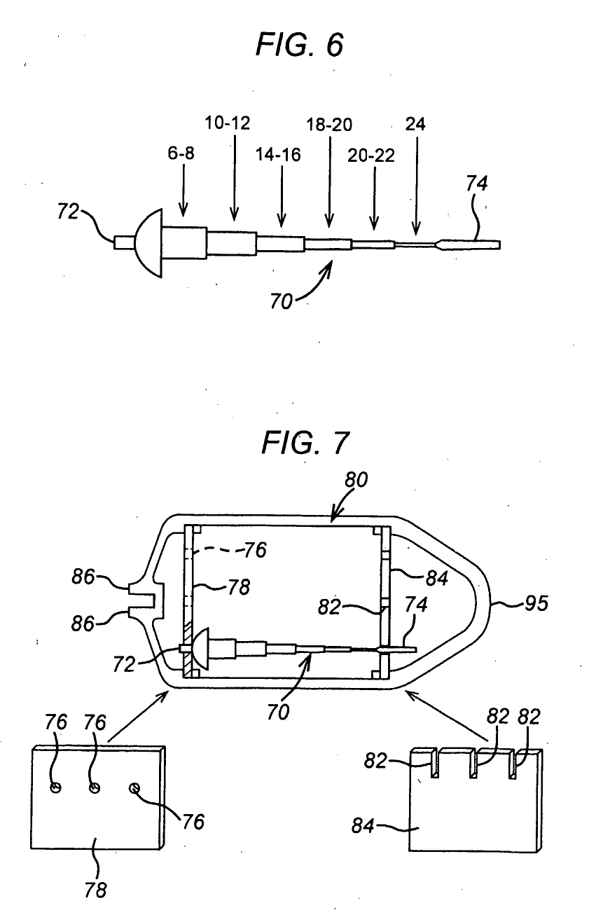

FIG. 6 is a side view of a fishing hook holder in accordance with a second embodiment of the invention,

FIG. 7 is a plan view of a base part of a fishing hook holder receptacle in accordance with a second embodiment of the invention, showing the fishing hook holder of FIG. 6 arranged therein, and details of parts of the receptacle,

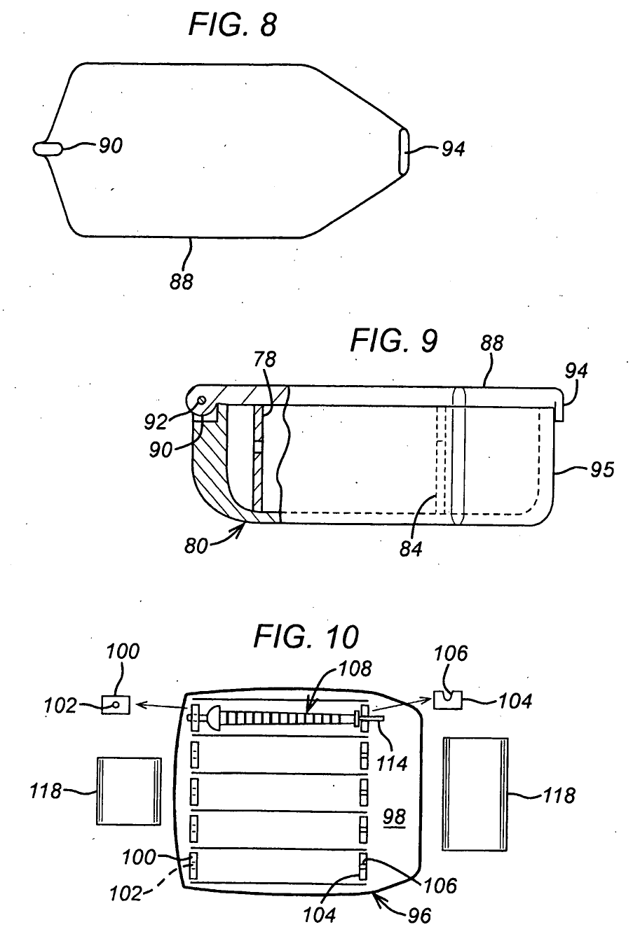

FIG. 8 is a plan view of a lid part for the base part of a fishing hook holder receptacle shown in FIG. 7,

FIG. 9 is a schematic side view and cross-section of the fishing hook holder receptacle base and lid shown in, respectively, FIG. 7 and FIG. 8, fitted together,

FIG. 10 is a plan view of a fishing hook holder receptacle in accordance with a third embodiment of the invention, and a fishing hook holder arranged therein,

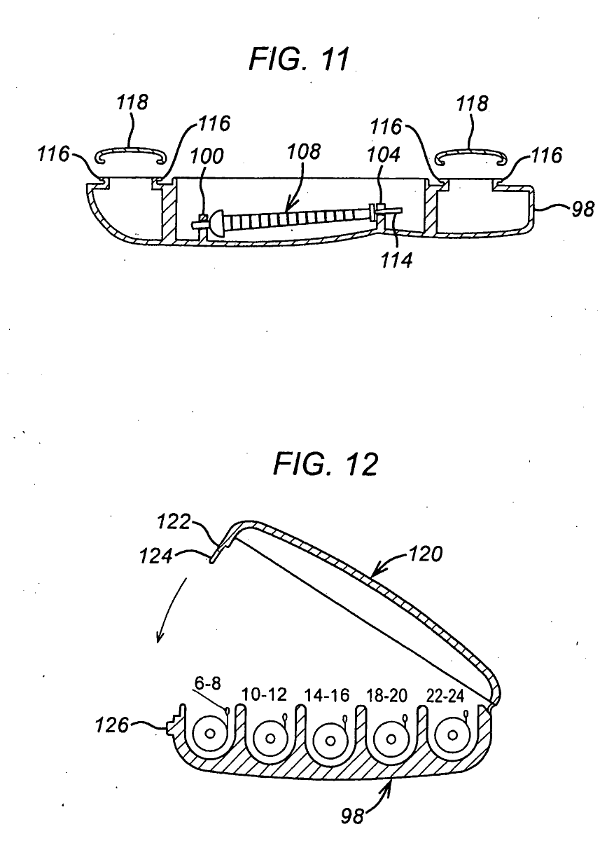

FIG. 11 is a schematic side view, partially in cross-section, of the fishing hook holder receptacle in FIG. 10, and the fishing hook holder arranged therein,

FIG. 12 is a schematic end view, partially in cross-section, of the fishing hook holder receptacle shown in FIG. 10, showing a plurality of fishing hook holders arranged therein,

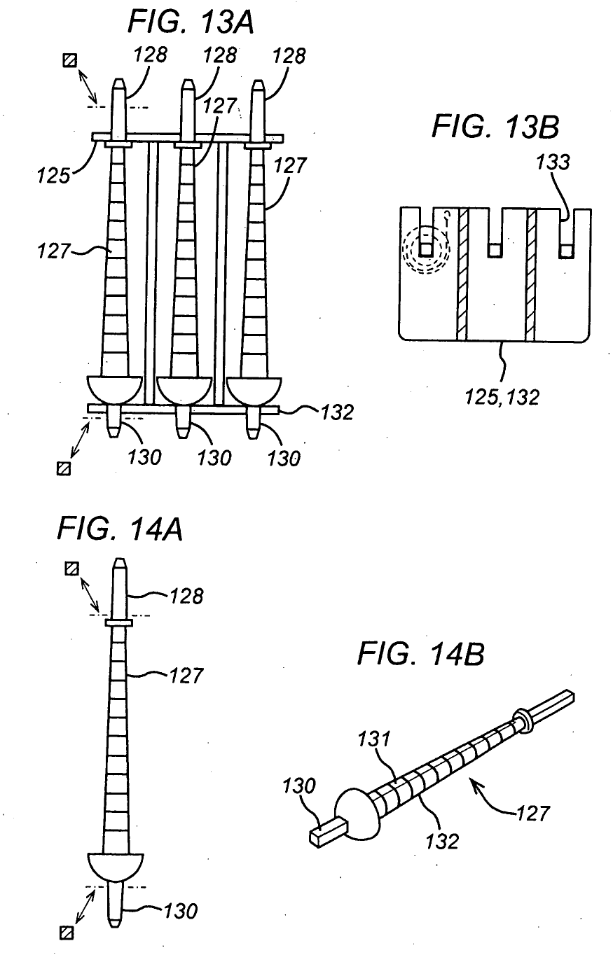

FIG. 13A is a plan view of a plurality of fishing hook holders in accordance with a third embodiment of the invention arranged on an insert for a fishing hook holder receptacle in accordance with a fourth embodiment of the invention,

FIG. 13B is a side view of the insert shown in FIG. 13A,

FIG. 14A is a side view of one of the fishing hook holders shown in FIG. 13,

FIG. 14B is a perspective view of a fishing hook holder in accordance with a fourth embodiment of the invention,

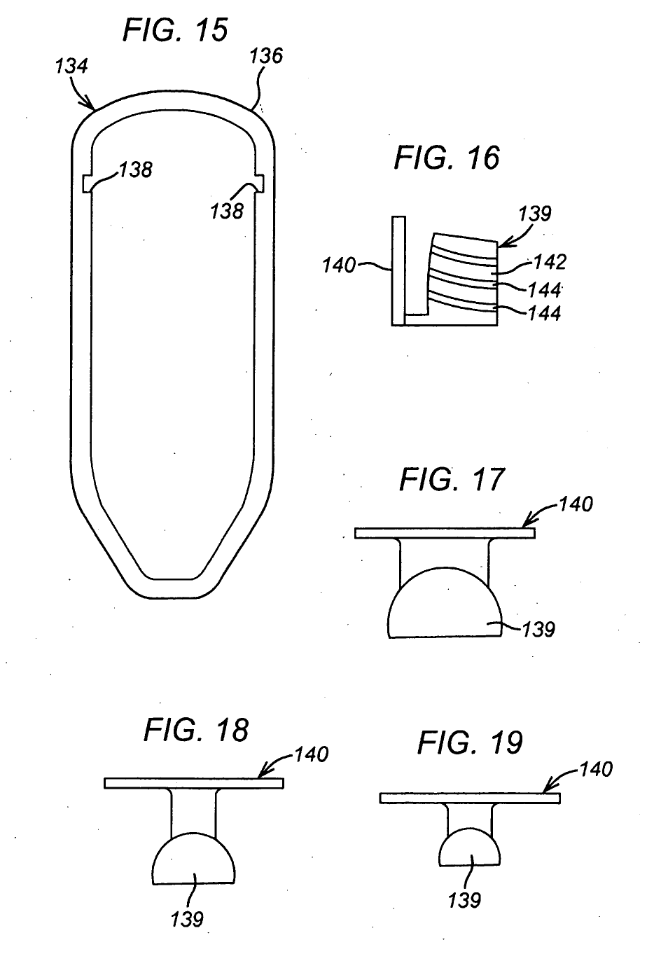

FIG. 15 is a plan view of a base part of a fishing hook holder receptacle in accordance with a fifth embodiment of the invention,

FIG. 16 is a side view of an insert which can be inserted into the base part of the receptacle shown in FIG. 15,

FIG. 17 is an end view of the insert shown in FIG. 16,

FIG. 18 is an end view of a different sized insert,

FIG. 19 is an end view of yet another different sized insert,

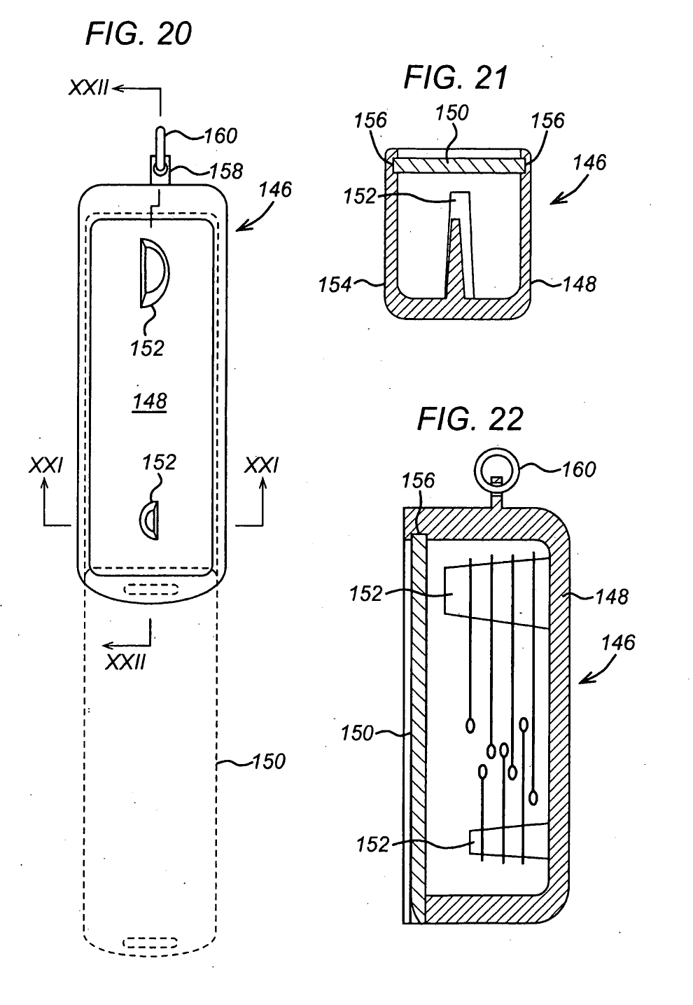

FIG. 20 is a plan view of a fishing hook holder receptacle in accordance with a sixth embodiment of the invention in the form of a keyring,

FIG. 21 is a cross-section of the fishing hook holder receptacle keyring shown in FIG. 20, taken along line XXI,

FIG. 22 is a further cross-section of the keyring shown in FIG. 20, taken along line XXII, and showing fishing hooks arranged therein,

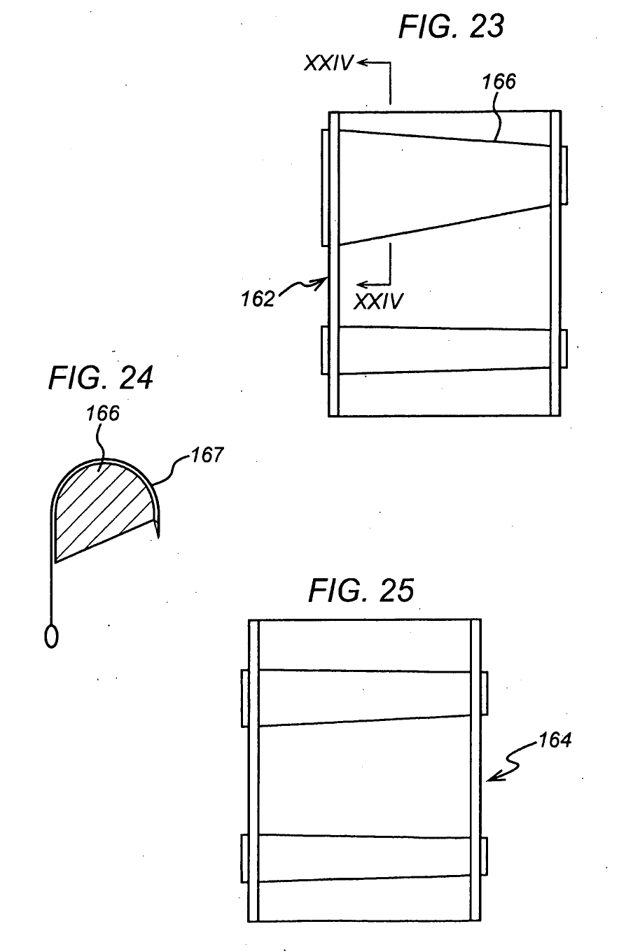

FIG. 23 is a plan view of a plurality of fishing hook holders in accordance with a fifth embodiment of the invention, in the form of an insert for a fishing hook holder receptacle,

FIG. 24 is a cross-section of the holders shown in FIG. 23, taken in the direction of the arrow XXIV.

FIG. 25 is a plan view of a plurality of fishing hook holder in accordance with a sixth embodiment of the invention in the form of a further insert for a fishing hook holder receptacle,

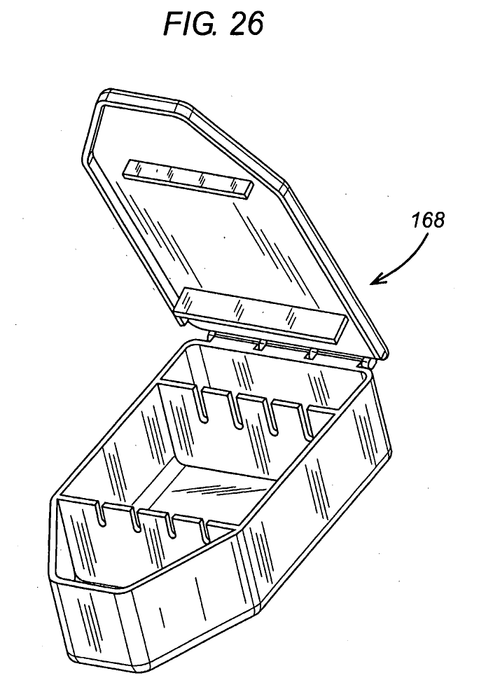

FIG. 26 is a perspective view of a fishing hook holder receptacle in accordance with a seventh embodiment of the invention,

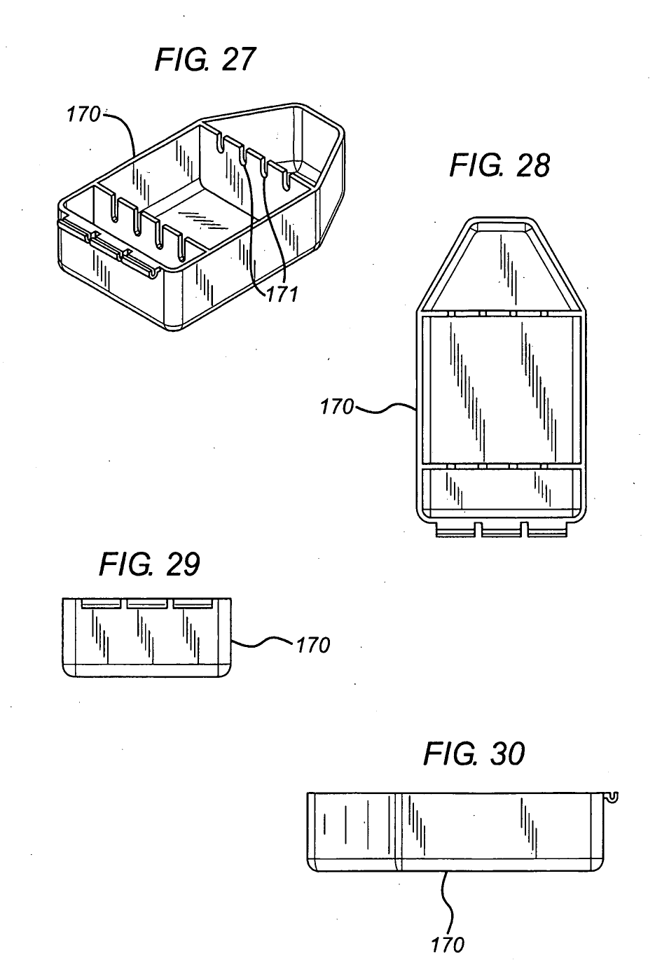

FIG. 27 is a perspective view of a base part of the receptacle shown in FIG. 26,

FIG. 28 is a plan view of the base plan shown in FIG. 27,

FIG. 29 is an end view of the base part shown in FIG. 27,

FIG. 30 is a side view of the base part shown in FIG. 27,

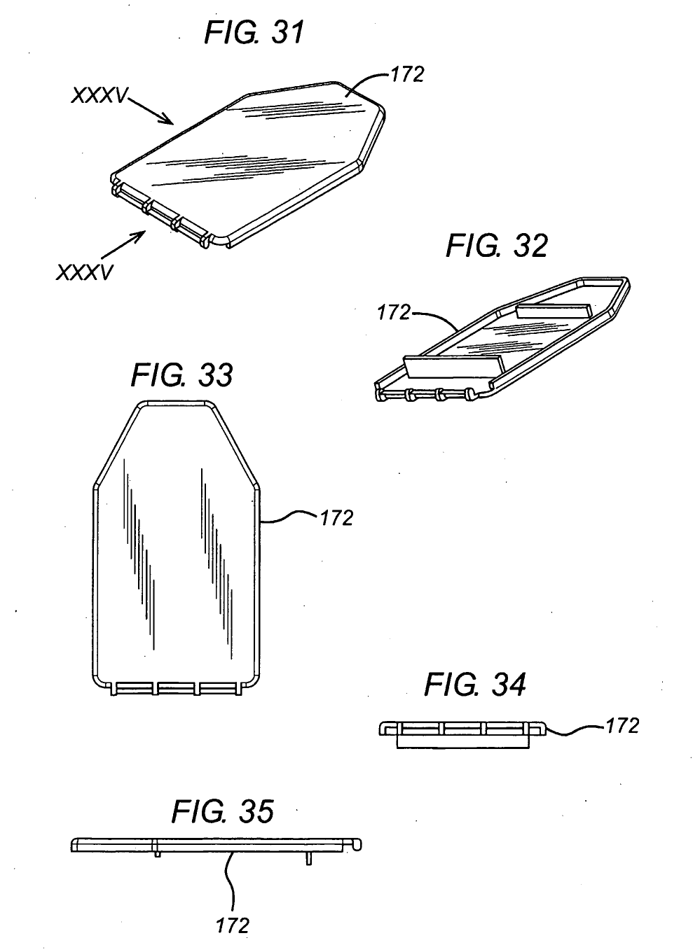

FIG. 31 is a perspective view of a lid of the receptacle shown in FIG. 26,

FIG. 32 is a further perspective view from below of the lid shown in FIG. 31,

FIG. 33 is a plan view from above of the lid shown in FIG. 31,

FIG. 34 is an end view of the lid shown in FIG. 31, taken in the direction of Arrow XXXIV.

FIG. 35 is a side view of the lid shown in FIG. 31, taken in the direction of Arrow XXXV,

FIG. 36 is a plan view of a base part of a receptacle in accordance with an eighth embodiment of the invention,

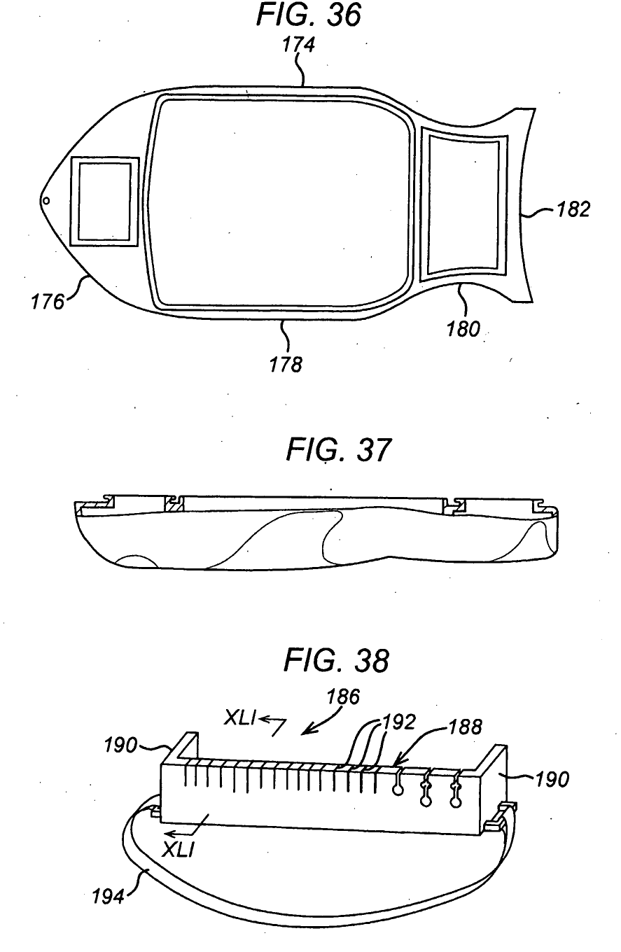

FIG. 37 is a side view of the base part shown in FIG. 36,

FIG. 38 is a perspective view of a fishing hook holder in accordance with a seventh embodiment of the invention,

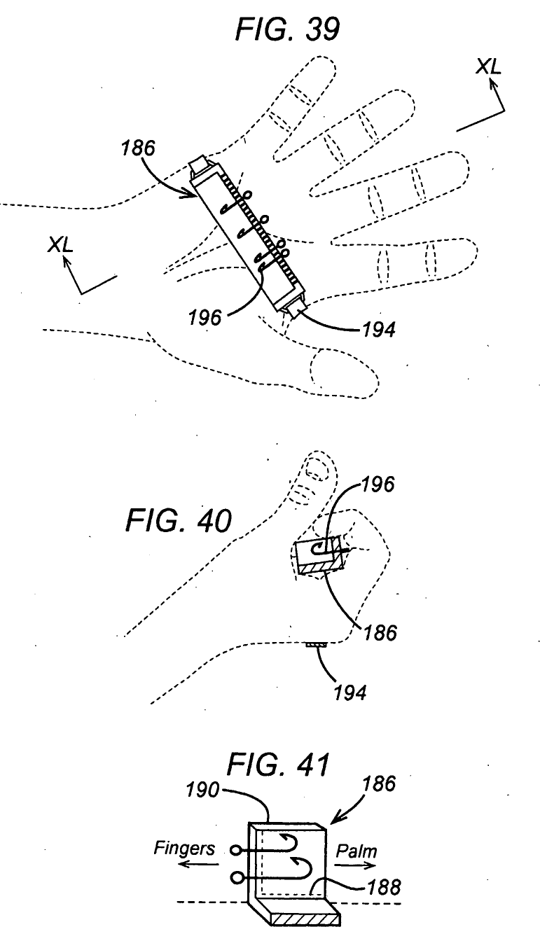

FIG. 39 is a perspective view showing the holder of FIG. 38 on a user,

FIG. 40 is a detailed view showing a cross-section of the holder whilst the holder is worn by a user, along line XL-XL in FIG. 39, when the user's band is folded,

FIG. 41 is a perspective view of the holder shown in FIG. 38, taken along the line XLI-XLI,

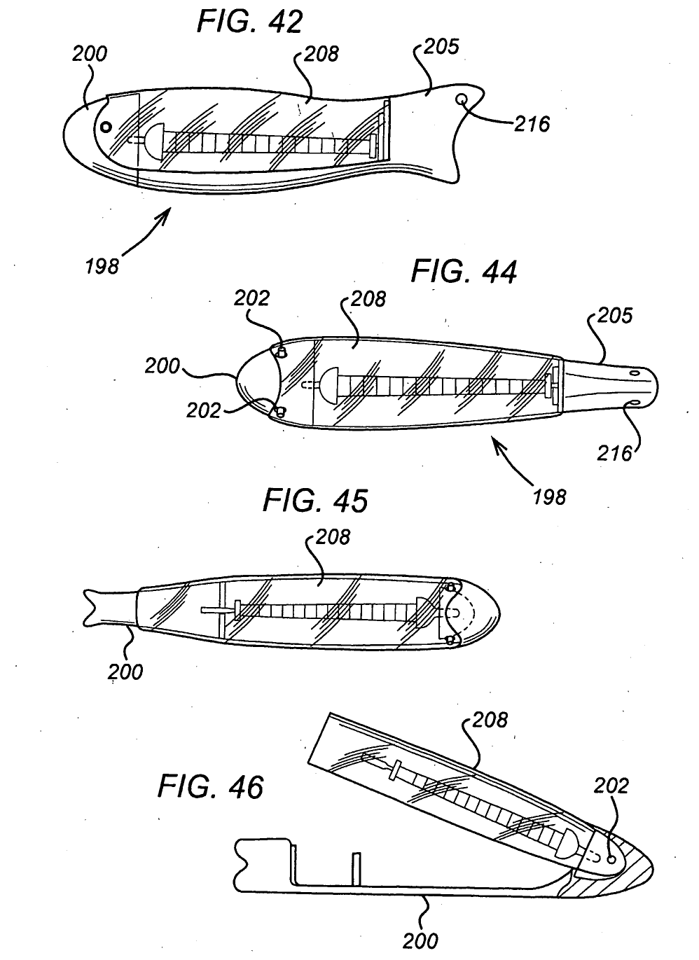

FIG. 42 is a plan view of a fishing hook holder receptacle in accordance with a ninth embodiment of the invention, and a fishing hook holder arranged therein,

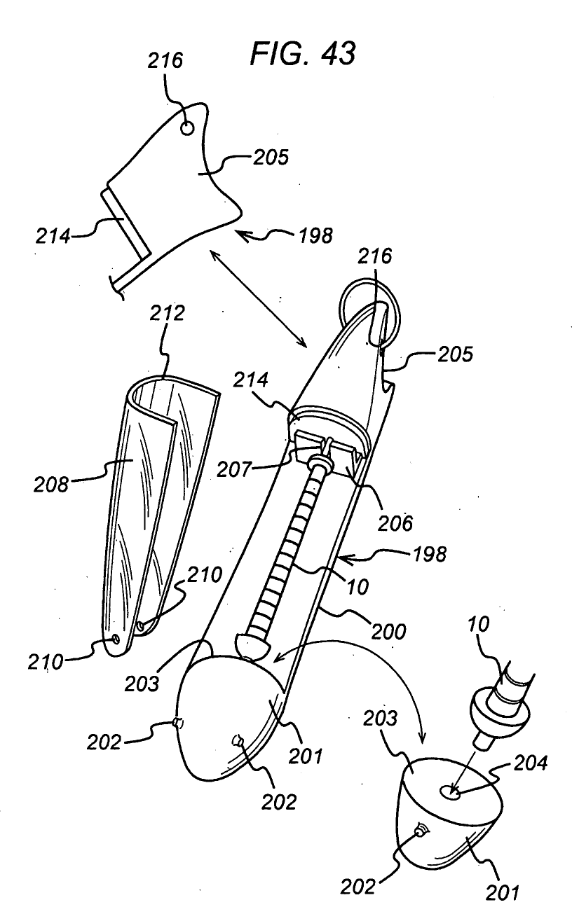

FIG. 43 is an exploded schematic perspective view showing parts of the receptacle of FIG. 42,

FIG. 44 is a plan view of part of the holder of FIG. 42,

FIG. 45 is a plan view of a receptacle in accordance with a tenth embodiment of the invention, and a fishing hook holder arranged therein, and

FIG. 46 is a side view of the receptacle shown in FIG. 45 in use.

Referring to FIG. 1, a fishing hook holder (10) in accordance with the invention comprises a holder part (12). The holder part (12) is elongate and tapers along its length. The holder part (12) has first and second handles (14, 16) extending from both of its ends and co-axially therewith. The first and second handles (14, 16) have rounded free ends.

In between the first handle part (14) and the holder part (12) is a first annular flange (18). In between the second handle part (16) and the holder part (12) is a second annular flange (20).

Referring to FIG. 2, the holder part (12) comprises eleven annular recesses (22) spaced at regular intervals along its length.

Referring to FIGS. 1 and 3, the holder part (12) is of generally circular cross-section. However, the periphery of the holder part (12) comprises a flat section (24) which extends at least partially along its length. At any point along the length of the holder part (12), the flat section (24) has the same angular extent about the circumference of the holder part (12). The flat section (24) extends from the second flange to a point between the second and third annular recesses.

Referring to FIG. 4, the second flange part (20) has a diameter of approximately 10 millimetres.

Referring to FIG. 5, the fishing hook holder (10) is arranged in a receptacle (30), made of a plastics material.

The receptacle (30) comprises a base (32) and a lid (34) which are hinged together. The lid and/or the base can be transparent. A resiliently deformable catch (36) on the lid (34) cooperates with an abutment (38) on the base (32) so as to keep the receptacle (30) closed.

The base (32) has a storage unit (40) arranged therein. The storage unit (40) has a first wall (42) and a second wall (44) which are arranged parallel to one another. Each of the first wall (42) and the second wall (44) comprises a plurality of mouths (46). The mouths (46) are resiliently deformable and open into throats (48) of a larger diameter than the openings of the mouths (46). The mouths (46) on the first wall (42) are arranged in line with the mouths (46) on the second wall (44).

The base (32) also comprises first, second and third supplementary storage regions (50, 52 and 54).

The base (32) also comprises a flange (56) at one end thereof, which defines a first aperture (58) and a second aperture (60) therethrough. A loop of material (not shown) such as string can be fed, at each end, through the apertures (58 and 60) and secured so that the free ends do not pass back through the apertures (58 and 60). The loop of material can be sufficiently long that it can be passed over the head, or around the waist, of a user.

In use, the handles, (14, 16) of the fishing hook holder (10) are pushed through the resilient mouths (46) so that they sit in the throats (48). The first annular part and the second annular part (18, 20), cooperate with the walls (42, 44) to prevent axial movement of the fishing hook holder (12).

The first, second and third storage regions (50, 52, 54) can be used to store fishing tackle such as weights or flies, or a small torch, or a magnifying glass. In another embodiment which is not shown the receptacle can be easily modified to hold larger accessories such as floats. Each of the second and third storage regions (52, 54) can have a lid. A hinge for lids of the regions is located in a cavity between the regions. Alternatively, the wall between the second and third storage regions (52, 54) can have two pairs of resilient mouths (not shown) like mouths (46). Each lid has a rod which pivotably locates in one of the pairs of mouths.

Referring to FIG. 6, a second fishing hook holder (70) in accordance with the invention has a first handle (72) like the first handle (14) on the fishing hook holder (10). However, the fishing hook holder (70) comprises a second handle (74) of non-circular cross-section. In particular, the second handle (74) has a rectangular cross-section.

Referring to FIG. 7, the first handle (72) cooperates with one of a plurality of circular apertures (76) in a wall (78) of a base of a second receptacle (80) in accordance with the invention. The second handle (74) is designed to be received by one of a plurality of slots (82) in a wall (84) of the receptacle (80). The second handle (74) is a close fit in the slot (82). In his way, rotational movement of the fishing hook holder (70) is minimised. This allows the eyes of hooks to be arranged so as to point upwards, and stay in that position for ease of threading during use.

The base of the receptacle (80) comprises flanges (86) at one end thereof.

Referring to FIG. 8, a lid (88) has a tab (90) extending perpendicularly therefrom. The tab (90) shown in FIG. 8 is arranged within the first and second flanges (86) of the base of the receptacle shown in FIG. 7 and secured in place by a hinge (92) as shown in FIG. 9.

Referring to FIGS. 8 and 9, the lid (88) also comprises a flap (94) which is slightly resilient. The resilient nature of the flap (94) means that when the lid (88) is closed the flap (94) grips against an outer wall (95) of the receptacle base (80).

In FIGS. 10 to 12, a third receptacle (96) in accordance with the invention has a base part (98) from which a plurality of walls (100, 104) extend upwardly. The first walls (100) are like walls (78) in that they each define a circular aperture (102) therethrough. The second walls (104) comprise trapezoidal slots (106) of which the broader sides face upwards.

A fishing hook holder (108) has a first handle (114) of a cross-section which is complimentary with the trapezoidal slots (106) in the second wall (104). In this way, rotational movement of the fishing hook holder (108) is minimised.

Referring to FIG. 11, the base (98) of the receptacle (96) comprises lid retainers (116). Each lid retainer (136) comprises two parallel walls extending upwardly from the base (98). Each of the upwardly extending walls is of L-shaped cross-section. The walls are arranged symmetrically so that the free ends of the walls point away from one another. Lids (118) of C-shaped cross-section can be slid into place so that the free ends of the lid (118) sit under the free ends of each wall of the lid retainer (116). Referring to FIG. 12, the main lid (120) is hinged to the base part (98) of the receptacle. The lid (120) comprises a flange (122) which defines an aperture (124). Aperture (124) can be closed or in the form of an open mouth. The point at which the flange (122) is connected to the lid (120) acts as a live hinge. The base (98) defines a protrusion (126) of a complimentary shape to the aperture (124). In use, the flange (122) can be passed over the protrusion (126) so the aperture (124) retains the protrusion (126) and keeps the lid closed against the base.

Referring to FIG. 13A, a fishing hook holder (127) in accordance with a third embodiment of the invention has first and second handles (128, 130) of rectangular, and in particular square, cross-sections. The handles (128, 130) are a close fit with slots (133) of an insert (125) for a receptacle in accordance with a further embodiment of the invention so as to minimise rotational movement of the fishing book holder.

Referring to FIG. 13B, a hook sits within an annular groove on the holder part (shown in broken line).

Referring to FIG. 14A, a second handle (130) tapers whilst maintaining a square cross-section. That helps to prevent axial movement of the holder. Referring to FIG. 14B, the periphery of the holder (127) has a flat section (131) like the flat section (124) of holder (10) and a further flat section (132) on the opposite side of the holder (127). The two flat sections (131, 132) are intended to cooperate with respectively, the part of the hook adjacent the tip and the part of the hook opposed to the tip. The second handle (130) has a uniform cross-section along its length.

Referring to FIG. 15, a base (134) for a receptacle in accordance with a fifth embodiment of the invention is shown. A wall (136) of the base defines two slots (138), which oppose each other.

Referring to FIG. 16, a removable insert (139) comprises a wall (140). The wall (140) is arranged so that each of its ends sits in one of the slots (138) of the base (134). The length of the wall (140) is slightly less than the distance between the bases of the two slots (138) and the width of the wall (140) is slightly less than the distance between the two wall (136) parts defining each slot (138). The walls of the insert (125) above can be arranged in slots defined by a receptacle in a similar manner. The insert can be temporarily locked in place using suitable catch means.

Still referring to FIG. 16, the insert (139) comprises a fishing hook holder (142) in another embodiment in accordance with the invention, which is elongate and, as can be seen in FIGS. 17 to 19, roughly hemispherical cross-section. The fishing hook holder (142) has a plurality of grooves (144) defined therein at regular intervals along its length, which are intended to receive fishing hooks. As shown in FIGS. 17 to 19, the fishing hook holder (142) can come in various sizes to accommodate different size hooks. Alternatively, the fishing hook holder (142) can be built from (layers of) shaped foam.

Referring to FIG. 20, a fishing hook holder receptacle (146) in accordance with a sixth embodiment of the invention for “deep sea” fishing hooks, comprises a base part (148) and a lid part (150). The base part (148) comprises two upstanding fishing hook holders (152) in accordance with the invention extending therefrom.

Referring to FIGS. 21 and 22, the fishing hook holders (152) extend almost to the lid (150) to maximise storage space and can taper along their length. In that way, hooks of different sizes can be accommodated on the holders (152).

Referring to FIG. 21, a wall (154) of the base part defines slots (156) on the inside surface thereof. The lid, (150) slides in the slots (156) to close the receptacle (146).

Referring to both FIGS. 20 and 22, the receptacle (146) comprises a tab (158) which defines an aperture for a key ring (160). This way, the receptacle (146) can easily be worn on the belt of the user.

Referring to FIGS. 23 and 25, replacement insert frames (162, 164) carrying holders (166) in accordance with a fifth embodiment of the invention can be provided to accommodate different sized hooks. The inserts (162, 164) can be shared in a normal fishing tackle box and replace another sized frame in a receptacle when appropriate. Referring to FIG. 24 a hook (167) can be installed on the fishing hook holder (166) as shown.

Referring to FIG. 26 to 35, yet another receptacle (168) in accordance with a seventh embodiment of the invention is shown.

Referring to FIGS. 27 to 30, the receptacle (168) comprises a base part (170). Slots (171), like slots (133), in walls can receive a holder in accordance with the invention. The walls can be removable from the base part like the wall (140). Referring to FIGS. 31 to 35, the receptacle (168) comprises a lid (172). The lid (172) is hingeably connected to the base part (170). Walls 173 on the underside of the lid (172) abut against the walls on the base part (170).

Referring to FIGS. 36 and 37, an outer surface of a base for a fishing hook receptacle (174) in accordance with the inventions can have the shape of, or alluding to, a fish. Receptacle (174) can have a distinct headend (176), and a main body part (178) narrowing in at a waist (180) before flaring out into a tail (182). Referring to FIG. 40 the base (174) can be marked or shaped to show the fish eye or eyes, a fish fin or fins and/or a fish tail.

Referring to FIGS. 38 to 41, a fishing hook holder (186) in accordance with a seventh embodiment of the invention has a holder part (188) of approximately L-shaped cross-section (shown in dashed line in FIG. 44). The fishing hook holder (186) comprises protective walls (190) at each end of the holder part (188). The holder part (188) has a series of slots (192) arranged at intervals along its length. As shown in FIG. 41, the slots (192) can extend to different depths. Consequently, as shown in FIG. 44, the hooks when arranged in the slots can sit at different heights. The fishing hook holder (186) can be closed around the sharp pointed end and barb of the hook by the provision of a suitable guard attached to the holder part 188.

Referring to FIGS. 42 to 44, a fishing hook holder receptacle (198) in accordance with another embodiment of the invention comprises a body (200). At one end of the body is a first retaining part which happens to be in the form of a head (201). The head (201) has two protrusions 202, each extending from opposite sides of the outside surface of the head. The Tear of the head (203) is solid and has an aperture (204) defined therein. The hole (204) can receive a handle of the holder. At a second end of the body is a second retaining part which happens to be in the form of a tail (205). The tail (205) has a wall (206) defining a slot 207 for another handle of a holder. A clear plastics hood (208) has two apertures (210) which correspond to the position of the protrusions 202. The hood (208) pivots with respect to the body (200) at the protrusions 202. Resilient of the hood 208 allows a free end 212 thereof to come to a close against the tail 201, the free end 212 sitting on a shoulder 214. The tail 201 also has an aperture for a key ring.

In use, a holder 10 can be stored in the compact receptacle (198).

In an alternative embodiment of the invention (not shown), where a plurality of fishing hook holder can be fixed to a receptacle, a first part of each fishing hook holder can be fixed to the receptacle at a pivot and a second part of each fishing hook holder can be pivoted with respect to the receptacle. Each of the fishing hook holders can therefore be independently selectable and movable with respect to the receptacle when needed. Each fishing hook holder is movable through about 90 degrees, so that the selected fishing book holder is more accessible.

In use, a fisher person can tie the line to the hook without removing the hook from the holder.

1. A fishing hook holder comprising a holder part for receiving a hook, the holder part being arranged so that a hook can at least partially straddle the holder part.

2. A fishing hook holder according to claim 1, wherein the holder part is elongate.

3. A fishing hook holder according to claim 1 or 2, wherein the holder part is of uniform width along its length.

4. A fishing hook holder according to claim 1 or 2, wherein the holder part varies in width along its length.

5. A fishing hook holder according to claim 4, wherein the width of the holder part only varies in one direction.

6. A fishing hook holder according to any preceding claim, wherein the holder part is shaped to be a close fit with the inbound surface of the U-shaped part of a fishing hook.

7. A fishing hook holder according to any preceding claim, wherein the holder part has a generally circular cross section.

8. A fishing hook holder according to claim 7, the holder part having a flat.

9. A fishing hook holder according to claim 8, wherein the flat part extends along at least part of the length of the holder part.

10. A fishing hook holder according to claim 9, wherein a second part of, the generally circular cross section, periphery, spaced from the first part, is flat.

11. A fishing hook holder according to claim 10, wherein the second flat part extends along at least part of the length of the holder part.

12. A fishing hook holder according to claim 11, wherein the first and second flat parts are spaced apart angularly.

13. A fishing hook holder according to any preceding claim, wherein the holder part is at least partially resilient.

14. A fishing hook holder according to any preceding claim, wherein the holder part has indicia informing the user that a hook of certain size can be stored at that location.

15. A fishing hook holder according to claim 14, wherein the indicia are arranged along the length of the holder part.

16. A fishing hook holder according to any preceding claim, wherein the holder part has one or more predefined hook receiving regions.

17. A fishing hook holder according to claim 16, wherein the holder part comprises a notch for receiving a hook barb.

18. A fishing hook holder according to claim 16 or 17, wherein the or each hook receiving region comprises an annular or partially annular recess to accommodate the looped part of a hook.

19. A fishing hook holder according to claim 18, wherein the holder part has one or more projection extending transversely therefrom.

20. A fishing hook holder according to claim 19, wherein the or each projection extends radially.

21. A fishing hook holder according to claim 20, wherein the or each projection is in the form of an annulus.

22. A fishing hook holder according to any of claims 18 to 21, wherein the holder part has two projections.

23. A fishing hook holder according to any preceding claim, wherein the fishing hook holder is fluorescent so as to glow continuously and/or luminous so as to glow-in-the-dark.

24. A fishing hook holder according to any preceding claim, wherein the fishing hook holder is stored on a key ring.

25. A fishing hook holder according to any preceding claim, wherein the fishing hook holder comprises a band enabling it to be worn around a part of the body.

26. A fishing hook holder according to any preceding claim, wherein the fishing hook holder comprises one or more hooks fitted thereto.

27. A fishing hook holder according to claim 26, wherein the holder part has indicia showing where hooks of a certain size are to be received, and is resilient and at the point the holder part is of slightly greater diameter than the distance between the tip of the hook and the opposing part of the hook.

28. A fishing hook holder according to claim 26 or 27, wherein the holder part has indicia showing where hooks of a certain size are to be received, and is resilient and the extent of the annular or partially annular recess is slightly less than the width of a hook so that the walls of the recess act to retain the hook.

29. A fishing hook holder according to claim 26 or 27 or 28, wherein the hook has an eye, and the eye of the hook is free, i.e. accessible, when the hook is held on the holder.

30. A fishing hook holder according to claim 29, wherein fishing hook holder is mounted on a thread which can be worn around the body of a fisherperson.

31. A fishing hook holder according to any preceding claim, wherein the fishing hook holder is stored in a receptacle.

32. A fishing hook holder according to claim 31, wherein the fishing hook holder is removable from the receptacle.

33. A fishing hook holder according to claim 32, wherein the fishing hook holder “snap fits” into the receptacle.

34. A fishing hook holder according to claim 31, wherein the fishing hook holder is fixed with respect to the receptacle.

35. A fishing hook holder according to claim 34, wherein part of the fishing hook holder is fixed to the receptacle and part of the fishing hook holder is movable with respect to the receptacle.

36. A fishing hook holder according to any of claims 31 to 35, wherein the receptacle is closeable to be watertight.

37. A receptacle for a fishing hook holder in accordance with claims 1 to 36, wherein the receptacle comprising one or more fishing hook holder sites:

38. A receptacle according to claim 37, wherein the receptacle comprises one or more resilient mouth for a corresponding number of fishing hook holders.

39. A receptacle according to claim 37, wherein the receptacle comprises a fishing hook holder fixed thereto.

40. A receptacle according to claim 39, wherein part of the fishing hook holder is fixed to the receptacle and part of the fishing hook holder is movable with respect to the receptacle.

41. A receptacle according to claim 40, wherein each of the fishing hook holders is independently selectable and movable with respect to the receptacle.

42. A receptacle according to any of claims 40 or 41, wherein the fishing hook holder is movable through an angle of about 30 to 150 degrees, preferably about 90 degrees.

43. A receptacle according to claim 42, wherein the receptacle comprises a plurality of fishing hook holders fixed thereto.

44. A receptacle according to any of claim 31 to 43, wherein the fishing hook holder(s) is laden with hook(s), and the hook(s) is/are located in the receptacle such that the eye(s) of the hook(s) is/are uppermost.

45. A receptacle according to any of claim 31 to 44, wherein the receptacle comprises a removable housing insert for one or more fishing hook holders.

46. A receptacle according to claim 45, wherein the removable housing comprises at least one wall which locates in a recess defined in a wall of the receptacle.

47. A receptacle according to claim 45, wherein the removable housing comprises two or four walls which locate in, respectively, two or four recesses defined in a wall of the receptacle.

48. A receptacle according to any of claim 31 to 46, wherein the receptacle comprises a plurality of housings for different sized hooks.

49. A receptacle according to any of claim 31 to 48, wherein the receptacle is glow-in-the-dark.

50. A receptacle according to any of claim 31 to 49, wherein the receptacle has an integral magnifying glass or tweezers to assist the fisherperson.

51. A receptacle according to any of claim 31 to 50, wherein the receptacle is mounted on a thread which can be worn around the neck of a fisherperson.

52. A receptacle according to any of claim 31 to 51, wherein the receptacle floats on water, and preferably floats even when the receptacle is full of water.

53. A method of making a fishing hook holder in accordance with any of claims 1 to 29, wherein the method comprises moulding the fishing hook holder.

54. A method of making a fishing hook holder according to claim 53, wherein the method comprises moulding the holder from a single piece of material.

55. A fishing hook holder, or fishing hook holder receptacle substantially as described herein and with reference to any of the drawings herein.
